(19) United States
(12) Patent Application Publication
(10) Pub. No.: US 2026/0195268 A1
(43) Pub. Date: Jul. 9, 2026

(54) Data Processing Method with a Partially Precise Snoop Filter

(71) Applicant: MEDIATEK INC., Hsinchu City (TW)

(72) Inventors: Pi-Hai Liu, Hsinchu City (TW); Wen-Kai Huang, Hsinchu City (TW); Hsu- Li Chiu, Hsinchu City (TW)

(73) Assignee: MEDIATEK INC., Hsinchu City (TW)

(21) Appl. No.: 19/010,151

(22) Filed: Jan. 5, 2025

(51) Int. Cl. G06F 12/0802

(52) U.S. Cl. CPC G06F 12/0802; G06F 2212/60

(57) ABSTRACT

A data processing method includes receiving a read request or a write request with an address of data, checking a value of a counter indicator when a miss of the address is responded by the snoop filter, and snooping at least two of the clusters when the counter indicator presents a first outcome.

### BACKGROUND

With the rapid advancement of technologies, various processing devices having cache memories can perform a data-sharing mechanism. Further, multi-core processors are widely used for various applications since they can provide parallelism of data traffic with relatively low complexity. However, achieving the coherence traffic between cores is a main issue for providing high data traffic performance and low power consumption. Currently, a snoop filter has been introduced for maintaining the coherence of data traffic. The snoop filter is a directory-based structure and can monitor all coherent traffic for keeping track of coherency states of cache blocks of multi-core processors or various processing devices.

However, since the snoop filter is a directory-based structure, a cache line conflict of the snoop filter may occur. When the snoop filter introduces the cache line conflict, a back invalidation process is executed, leading to information loss. In other words, the processor performance may be dropped due to the back invalidation process caused by the snoop filter.

Therefore, developing a snoop filter without introducing the back invalidation process for improving the data traffic performance is an important design issue.

### SUMMARY

In an embodiment of the present invention, a data processing method of a snoop filter for a plurality of clusters with caches is disclosed. The data processing method comprises receiving a read request or a write request with an address of data, checking a value of a counter indicator when a miss of the address is responded by the snoop filter, and snooping at least two of the clusters when the counter indicator presents a first outcome.

In another embodiment of the present invention, a data processing method of a snoop filter for a cache in a plurality of clusters is disclosed. The data processing method comprises receiving an allocating request, checking a counter indicator when a tag of the snoop filter is full, and allocating a cache line of the snoop filter by invalidating data in the cache when the counter indicator is greater than a threshold.

In another embodiment of the present invention, a data processing method of a snoop filter for a cache in a plurality of clusters is disclosed. The data processing method comprises receiving a de-allocating request with an address, checking a counter indicator when a miss of the address is responded by the snoop filter, and decreasing the counter indicator value by one when the counter indicator is greater than to zero.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a data processing system with a partially precise snoop filter according to an embodiment of the present invention.

FIG. 2 is an illustration of allocating a cache line to the snoop filter when the snoop filter of the data processing system in FIG. 1 is operated under a precise operation mode.

FIG. 3 is a data conflict illustration when a cache line is allocated to the snoop filter and the snoop filter of the data processing system in FIG. 1 is operated under an imprecise operation mode.

FIG. 4 is an illustration of data flows when the snoop filter of the data processing system in FIG. 1 is operated under the precise operation mode.

FIG. 5 is an illustration of data flows when the snoop filter of the data processing system in FIG. 1 is operated under the imprecise operation mode.

FIG. 6 is a flow chart of executing a read request of the cache line by the data processing system in FIG. 1.

FIG. 7 is a flow chart of executing a write request of the cache line by the data processing system in FIG. 1.

FIG. 8 is an illustration of allocating a cache line when the snoop filter of the data processing system in FIG. 1 is operated under the imprecise operation mode.

FIG. 9 is a flow chart of executing an allocation request of the cache line by the data processing system in FIG. 1.

FIG. 10 is a flow chart of executing a de-allocation request of the cache line by the data processing system in FIG. 1.

### DETAILED DESCRIPTION

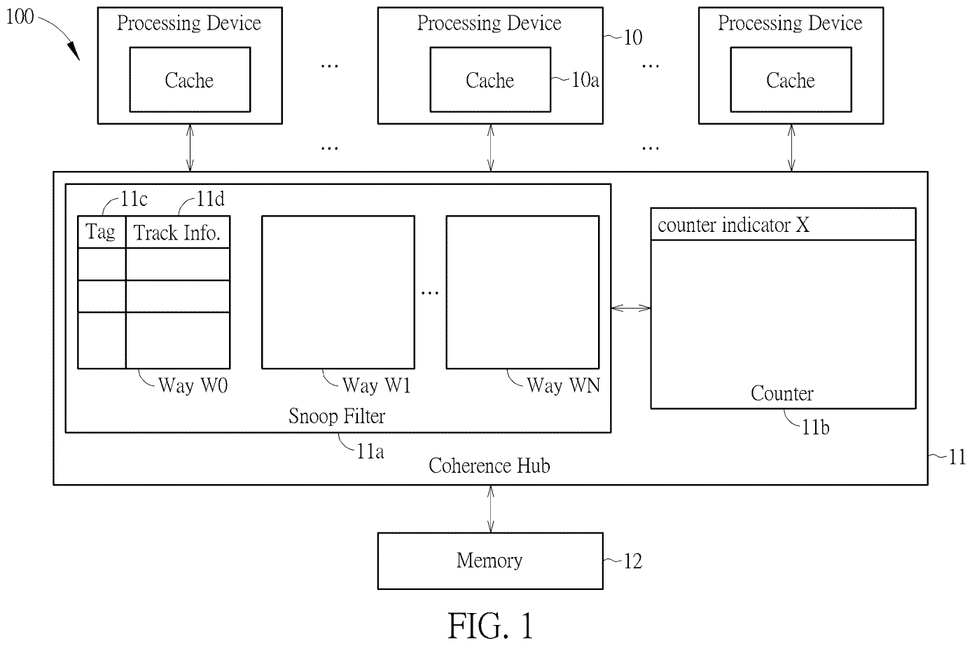

FIG. 1 is a block diagram of a data processing system 100 with a partially precise snoop filter according to an embodiment of the present invention. For simplicity, the data processing system 100 with a partially precise snoop filter is call as the data processing system 100 hereafter. The data processing system 100 includes a plurality of processing devices 10, a coherence hub 11, and a memory 12. The processing device 10 is used for processing data saved in a cache 10a. The coherence hub 11 is coupled to all processing devices 10. The coherence hub 11 includes a snoop filter 11a and a counter 11b. The snoop filter 11a is used for recording tracking information of cache lines. The counter 11b is linked to the snoop filter 11a for indicating the operation of the snoop filter 11a. Here, the snoop filter 11a is a directory-based structure. For example, the snoop filter 11a has a plurality of ways W0 to WN. Each way can be used for saving tag information 11c and track information 11d of the cache line. For example, the tag information 11c of the cache line can be a memory address of the cache line. The track information 11d of the cache line can be source information of the cache line. The counter 11b can be a digital counter performed by a counter indicator X. The memory 12 is coupled to the coherence hub 11 for saving data. The memory 12 can be a dynamic random-access memory (DRAM), but is not limited thereto. Further, the plurality of caches 10a can be called as cache clusters. In other words, the cache clusters can be regarded as a module virtually partitioning the plurality of caches 10a into at least one group.

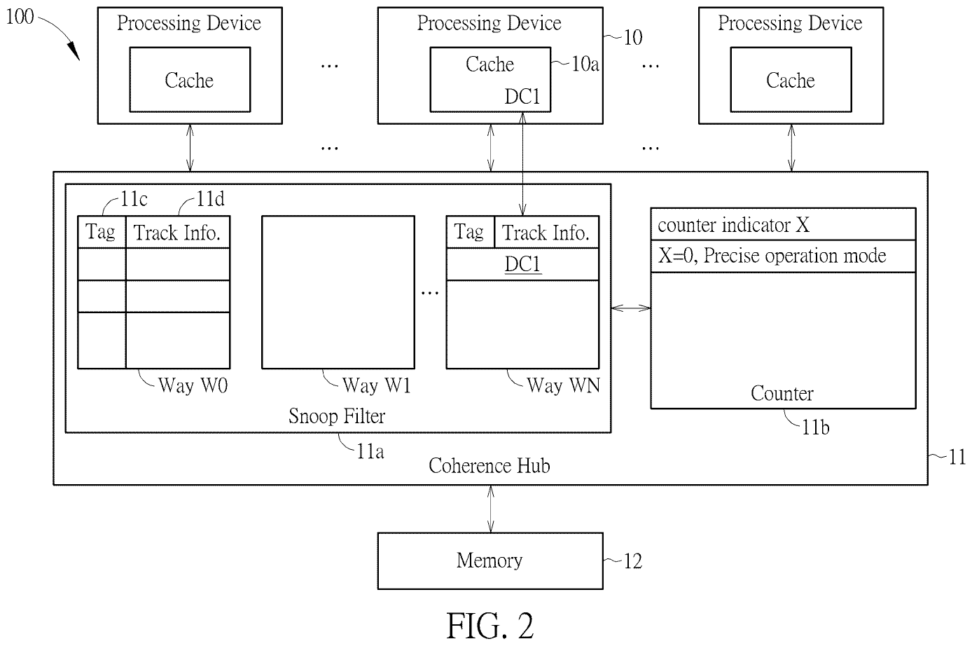

FIG. 2 is an illustration of allocating a cache line to the snoop filter 11a when the snoop filter 11a of data processing system 100 is operated under a precise operation mode. As previously mentioned, the snoop filter 11a can be a directory-based structure including the plurality of ways W0 to WN. Each way can be used for saving tag information and track information of the cache line. When the snoop filter 11a has at least one available data tracking tag space, it implies that the snoop filter 11a can save tag information and track information of the cache line DC1. Therefore, the counter indicator X can be maintained as a zero value (X=0). When the counter indicator X has the zero value, the snoop filter 11a is operated under the precise operation mode. A definition of the precise operation mode is that all tag information and track information can be mapped to cache lines of the processing device 10. As a result, the cache line DC1 can be allocated to the snoop filter 11a.

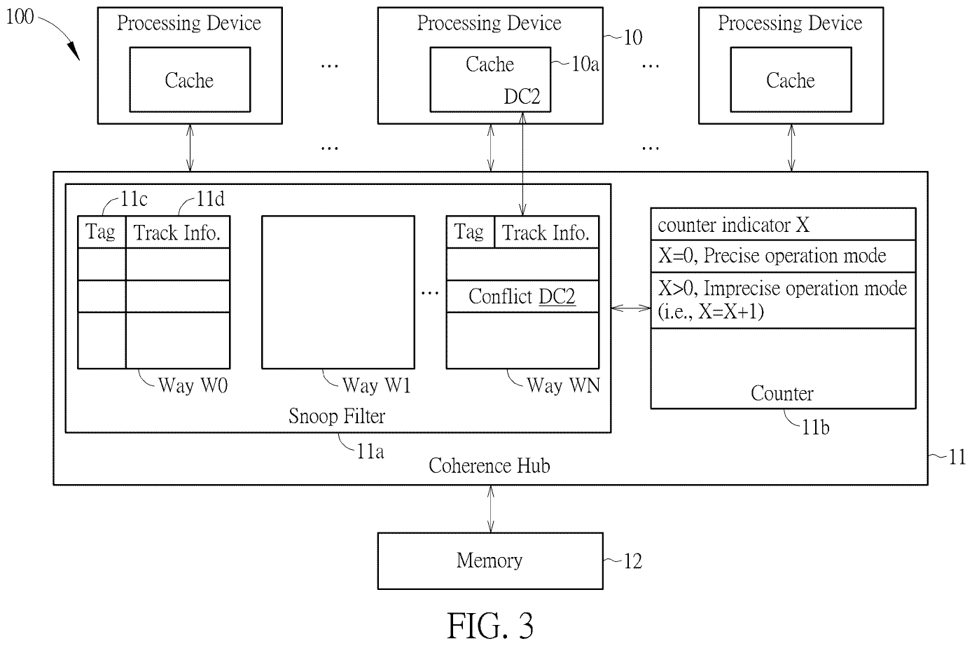

FIG. 3 is a data conflict illustration when a cache line DC2 is allocated to the snoop filter 11a and the snoop filter 11a of data processing system 100 is operated under an imprecise operation mode. As previously mentioned, the snoop filter 11a can be a directory-based structure including the plurality of ways W0 to WN. Each way can be used for saving tag information and track information of the cache line. When the cache line DC2 is prepared to be allocated to the snoop filter 11a and the snoop filter 11a has no available data tracking tag space, it implies that the snoop filter 11a is full and cannot save tag information and track information of the cache line DC2. Therefore, the data conflict of the cache line DC2 may occur. Instead of performing a back invalidation process of the snoop filter 11a, a value of the counter indicator X can be incremented (X=X+1). When the counter indicator X has a value greater than zero, the snoop filter 11a is operated under the imprecise operation mode. As a result, the cache line DC2 is not withdrawn and can be accessed when the cache 10a is snooped. In other words, in data processing system 100, the snoop filter 11a can be operated under the precise operation mode or the imprecise operation mode according to the value of the counter indicator X. Details of data flows of data processing system 100 are illustrated below.

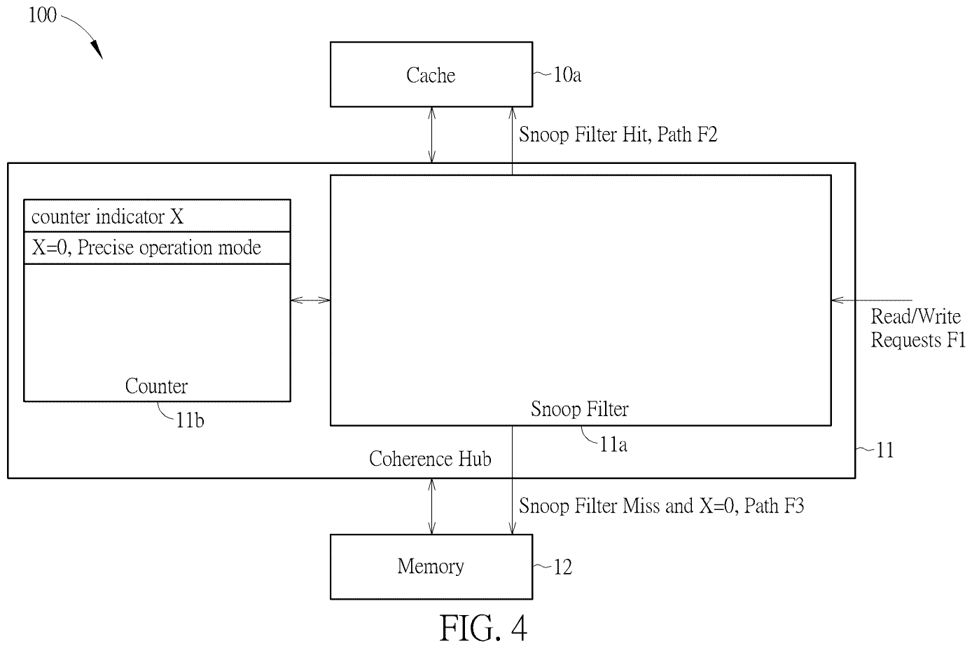

FIG. 4 is an illustration of data flows when the snoop filter 11a of data processing system 100 is operated under the precise operation mode. In FIG. 4, the read requests are received by the coherence hub 11 through a path F1. When the value of the counter indicator X is zero, the snoop filter 11a is operated under the precise operation mode. In FIG. 4, when the snoop filter 11a successfully locates data addresses of the read requests (i.e., say, the snoop filter 11a hits), the cache 10a can be snooped through a path F2. As a result, the coherence hub 11 accesses data from the cache 10a according to the read requests. Conversely, when the snoop filter 11a fails to locate data addresses of the read requests (i.e., say, the snoop filter 11a misses), the coherence hub 11 accesses data from the memory 12 according to the read requests through a path F3.

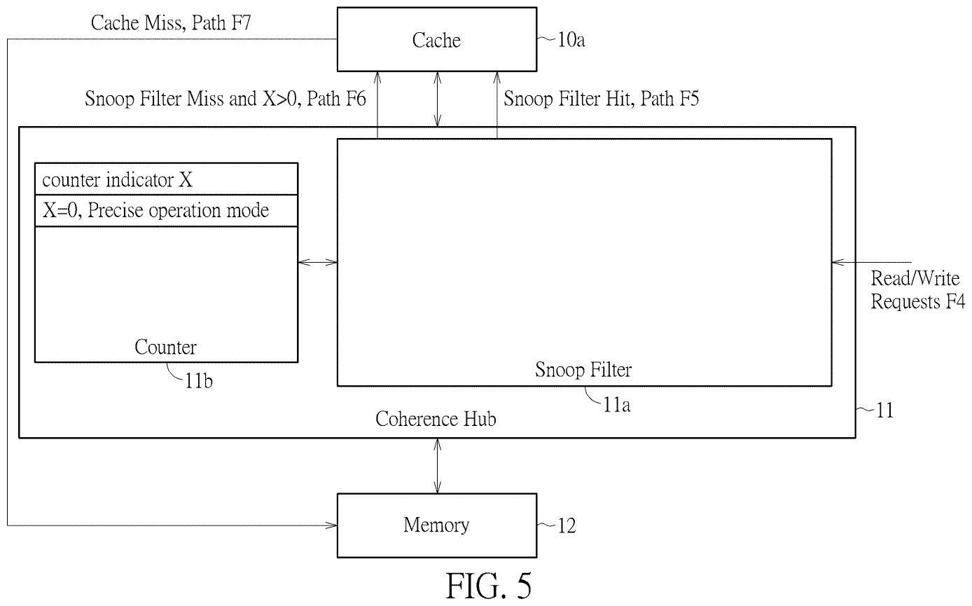

FIG. 5 is an illustration of data flows when the snoop filter 11a of data processing system 100 is operated under the imprecise operation mode. In FIG. 5, the read requests are received by the coherence hub 11 through a path F4. When the value of the counter indicator X is greater than zero, the snoop filter 11a is operated under the imprecise operation mode. In FIG. 5, when the snoop filter 11a successfully locates data addresses of the read requests (i.e., say, the snoop filter 11a hits), the cache 10a can be snooped through a path F5. When the snoop filter 11a fails to locate data addresses of the read requests (i.e., say, the snoop filter 11a misses), the coherence hub 11 still snoops the cache 10a according to the read requests through a path F6. Then, after the cache 10a is snooped, if the cache 10a successfully locates data addresses of the read requests (i.e., say, the cache 10a hits), the coherence hub 11 can access data from the cache 10a according to the read requests. Specifically, if writing the cache 10a is invalid, the snoop filter 11a can decrease the value of the counter indicator X. In another embodiment, after the cache 10a is snooped, when the cache 10a fails to locate data addresses of the read requests (i.e., say, the cache 10a misses), the coherence hub 11 can access data from the cache 10a to the memory 12 through a path F7.

In FIG. 4 and FIG. 5, the snoop filter 11a can be regarded as a “partially precise” based snoop filter since the snoop filter 11a can change its operation mode according to the counter indicator X. Since the snoop filter 11a can adaptively change operations. The snoop filter 11a can reduce back invalidation and provide a satisfactory cache hit rate. The snoop filter 11a can avoid some unnecessary snoop traffic. Further, since the counter 11b is introduced for indicating data conflict of the snoop filter 11a, the snoop filter 11a only requires a small filter space.

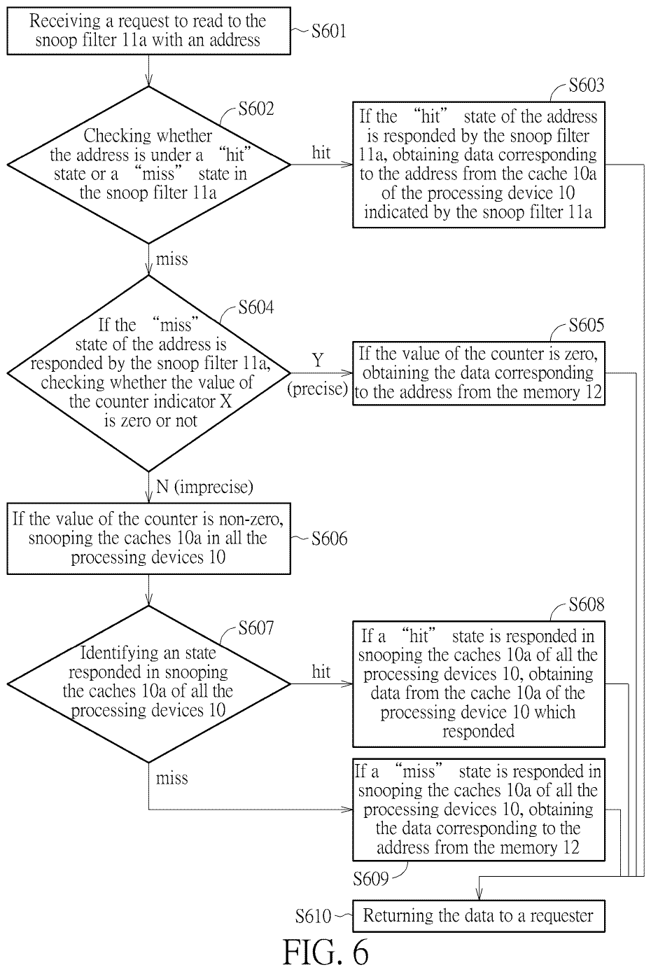

FIG. 6 is a flow chart of executing a read request of the cache line by the data processing system 100. The cache line read request is executed by the data processing system according to step S601 to step S610. Any hardware or technology modification falls in to the scope of the present invention. Step S601 to step S610 are illustrated below.
step S601: receiving a request to read to the snoop filter 11a with an address;
step S602: checking whether the address is under a “hit” state or a “miss” state in the snoop filter 11a;
step S603: if the “hit” state of the address is responded by the snoop filter 11a, obtaining data corresponding to the address from the cache 10a of the processing device 10 indicated by the snoop filter 11a;
step S604: if the “miss” state of the address is responded by the snoop filter 11a, checking whether the value of the counter indicator X is zero or not;
step S605: if the value of the counter is zero, obtaining the data corresponding to the address from the memory 12;
step S606: if the value of the counter is non-zero, snooping the caches 10a in all the processing devices 10;
step S607: identifying an state responded in snooping the caches 10a of all the processing devices 10;
step S608: if a “hit” state is responded in snooping the caches 10a of all the processing devices 10, obtaining data from the cache 10a of the processing device 10 which responded.
step S609: if a “miss” state is responded in snooping the caches 10a of all the processing devices 10, obtaining the data corresponding to the address from the memory 12;
step S610: returning the data to a requester.

In this embodiment, the snoop filter 11a may operate in both of the precise mode and the imprecise mode according to the value of the counter indicator X.

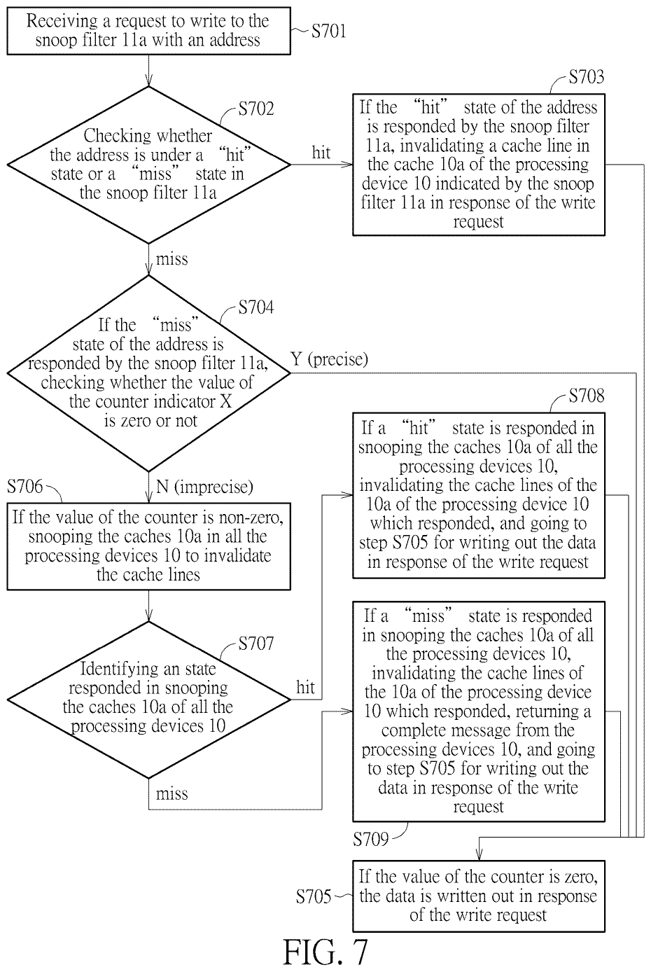

FIG. 7 is a flow chart of executing a write request of the cache line by the data processing system 100. The cache line write request is executed by the data processing system according to step S701 to step S709. Any hardware or technology modification falls in to the scope of the present invention. Step S701 to step S709 are illustrated below.
step S701: receiving a request to write to the snoop filter 11a with an address
step S702: checking whether the address is under a “hit” state or a “miss” state in the snoop filter 11a;
step S703: if the “hit” state of the address is responded by the snoop filter 11a, invalidating a cache line in the cache 10a of the processing device 10 indicated by the snoop filter 11a in response of the write request;
step S704: if the “miss” state of the address is responded by the snoop filter 11a, checking whether the value of the counter indicator X is zero or not;
step S705: if the value of the counter is zero, the data is written out in response of the write request;
step S706: if the value of the counter is non-zero, snooping the caches 10a in all the processing devices 10 to invalidate the cache lines;
step S707: identifying an state responded in snooping the caches 10a of all the processing devices 10;
step S708: if a “hit” state is responded in snooping the caches 10a of all the processing devices 10, invalidating the cache lines of the 10a of the processing device 10 which responded, and going to step S705 for writing out the data in response of the write request;
step S709: if a “miss” state is responded in snooping the caches 10a of all the processing devices 10, invalidating the cache lines of the 10a of the processing device 10 which responded, returning a complete message from the processing devices 10, and going to step S705 for writing out the data in response of the write request.

In this embodiment, the snoop filter 11a may operate in both of the precise mode and the imprecise mode according to the value of the counter indicator X.

In the following, a cache line allocation process of the snoop filter 11a is illustrated. When the value of the counter indicator X is zero, the snoop filter 11a is operated under the precise mode. In the precise mode, when the snoop filter 11a has at least one available data tracking tag space, the cache line can be allocated to the snoop filter 11a. When the snoop filter 11a has no available data tracking tag space, the cache line may be conflicted. Thus, the value of the counter indicator X is incremented (X=X+1).

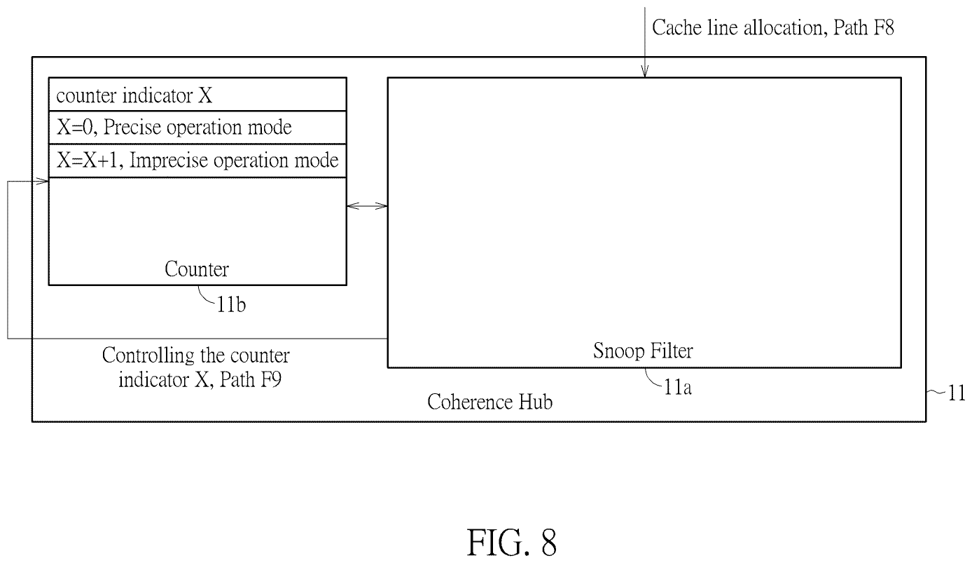

When the value of the counter indicator X is greater than zero, the snoop filter 11a is operated under the imprecise mode. FIG. 8 is an illustration of allocating a cache line when the snoop filter 11a of data processing system 100 is operated under the imprecise operation mode. As shown in FIG. 8, the cache line is prepared to be allocated to the snoop filter through a path F8. When the snoop filter 11a has no available data tracking tag space, the snoop filter 11a can control the counter indicator X through a path F9. As a result, the counter indicator X is incremented (i.e., X=X+1). Then, the snoop filter 11a is operated under the imprecise mode. In another embodiment, when the counter indicator X has a value greater than zero and snoop filter 11a has at least one available data tracking tag space, the cache 10a is snooped before the cache line is allocated. In another embodiment, when the counter indicator X has a value greater than zero and the snoop filter 11a has the at least one available data tracking tag space, if the snoop filter 11a fails to locate an address of the cache line, the cache line is allocated to the snoop filter 11a. In another embodiment, when the counter indicator X has a value greater than zero and the snoop filter 11a has the at least one available data tracking tag space, if the snoop filter 11a successfully locates an address of the cache line, the cache line is allocated to the snoop filter 11a and the value of the counter indicator X is decremented (i.e., X=X−1).

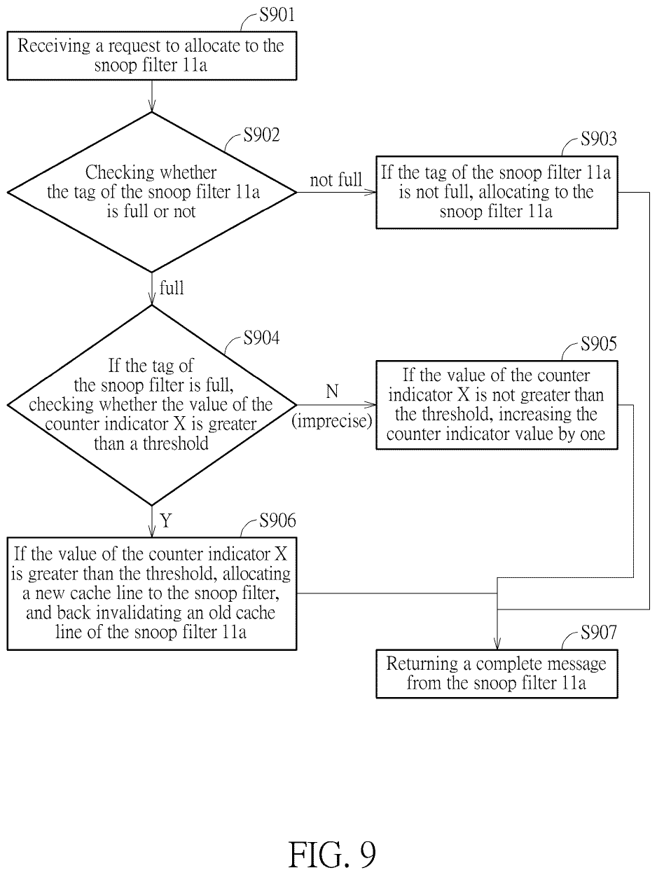

FIG. 9 is a flow chart of executing an allocation request of the cache line by the data processing system 100. The cache line allocation request is executed by the data processing system 100 according to step S901 to step S907. Any hardware or technology modification falls in to the scope of the present invention. Step S901 to step S907 are illustrated below.
step S901: receiving a request to allocate to the snoop filter 11a;
step S902: checking whether the tag of the snoop filter 11a is full or not;
step S903: if the tag of the snoop filter 11a is not full, allocating to the snoop filter 11a;
step S904: if the tag of the snoop filter is full, checking whether the value of the counter indicator X is greater than a threshold;
step S905: if the value of the counter indicator X is not greater than the threshold, increasing the counter indicator value by one;
step S906: if the value of the counter indicator X is greater than the threshold, allocating a new cache line to the snoop filter, and back invalidating an old cache line of the snoop filter 11a;
step S907: returning a complete message from the snoop filter 11a.

To be clear, the threshold of the value of the counter indicator X may be zero in the present embodiment. In this embodiment, the snoop filter 11a may operate in both of the precise mode and the imprecise mode according to the value of the counter indicator X.

In the following, a cache line de-allocating process of the snoop filter 11a is illustrated. After the snoop filter 11a receives a request for de-allocating a cache line, if the snoop filter 11a successfully locates an address of the cache line, the cache line is de-allocated from the snoop filter 11a. In another embodiment, after the snoop filter 11a receives the request for de-allocating the cache line, if the snoop filter 11a fails to locate an address of the cache line (i.e., say, the snoop filter 11a misses) and the counter indicator X has a value greater than zero (i.e., the snoop filter 11a is operated under the imprecise mode), the value of the counter indicator X is decremented (X=X−1).

In the aforementioned embodiments, since the value of the counter indicator X can be incremented (i.e., X=X+1) or decremented (X=X−1), the operation mode of the snoop filter 11a can be adaptively changed. For example, when the value of the counter indicator X is zero, the snoop filter 11a is operated under the precise mode. When the counter indicator X is incremented (X>0), the snoop filter 11a is operated under the imprecise mode. Then, when the counter indicator X is decremented (X=0), the snoop filter 11a is operated under the precise mode again. Since the operation mode of the snoop filter 11a can be adaptively changed, a hit rate and data processing efficiency can be improved without introducing information loss caused by back invalidation.

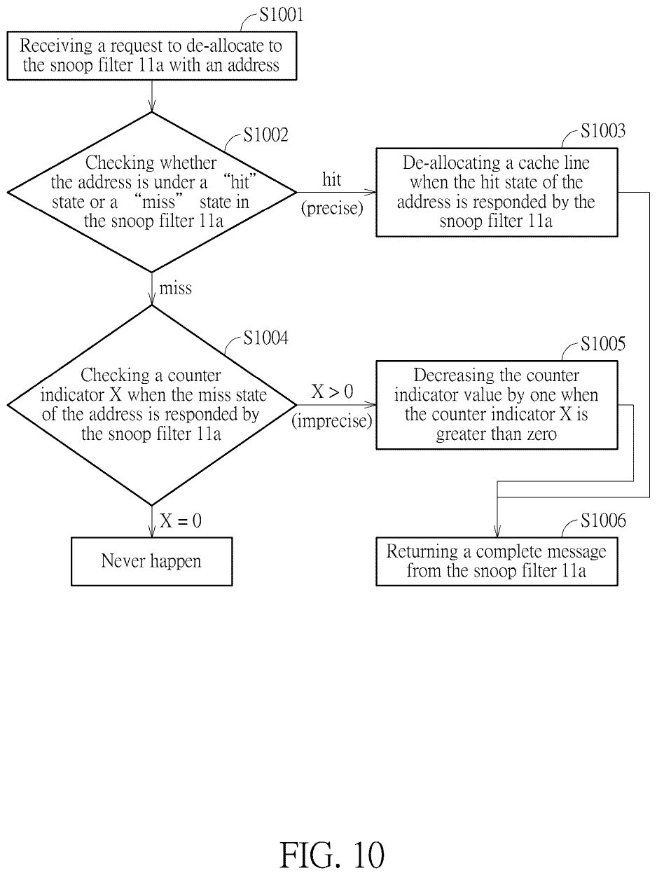

FIG. 10 is a flow chart of executing a de-allocation request of the cache line by the data processing system 100. The cache line de-allocation request is executed by the data processing system 100 according to step S1001 to step S1006. Any hardware or technology modification falls in to the scope of the present invention. Step S1001 to step S1006 are illustrated below.
step S1001: receiving a request to de-allocate to the snoop filter 11a with an address;
step S1002: checking whether the address is under a “hit” state or a “miss” state in the snoop filter 11a;
step S1003: de-allocating a cache line when the hit state of the address is responded by the snoop filter 11a;
step S1004: checking a counter indicator X when the miss state of the address is responded by the snoop filter 11a;
step S1005: decreasing the counter indicator value by one when the counter indicator X is greater than zero;
step S1006: returning a complete message from the snoop filter 11a.

In this embodiment, the snoop filter 11a may operate in both of the precise mode and the imprecise mode according to the value of the counter indicator X.

To sum up, the present invention discloses a data processing system and a data processing method with a partially precise snoop filter. The data processing system introduces a counter for assisting a snoop filter to process data conflict. Further, the snoop filter can adaptively select an appropriate operation mode from a precise operation mode and an imprecise operation mode according to a value of a counter indicator. Therefore, the snoop filter can reduce back invalidation and provide a satisfactory cache hit rate. Additionally, the snoop filter only requires a small filter space.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing method of a snoop filter for a plurality of clusters with caches comprising:
receiving a read request or a write request with an address of data;
checking a value of a counter indicator when a miss of the address is responded by the snoop filter; and
snooping at least two of the clusters when the counter indicator presents a first outcome.

2. The method of claim 1, wherein the first outcome is the counter indicator being greater than zero.

3. The method of claim 1, further comprising:
obtaining the data from a memory when the counter indicator presents a second outcome in response of the read request.

4. The method of claim 3, wherein the second outcome is the counter indicator being equal to zero.

5. The method of claim 1, further comprising:
obtaining the data from a cache of a cluster indicated by the snoop filter in response of the read request when a miss of the address is responded by the snoop filter.

6. The method of claim 1, further comprising:
invalidating a cache line in a cache of a cluster indicated by the snoop filter in response of the write request.

7. The method of claim 1, further comprising:
obtaining the data from a selected cluster in response of the read request if a hit is responded from the selected cluster when at least two of the clusters are snooped.

8. The method of claim 1, further comprising:
obtaining the data from a memory in response of the read request if a miss is responded from the clusters when at least two of the clusters are snooped.

9. The method of claim 1, further comprising:
invalidating a cache line in the selected cluster in response of the write request if a hit is responded from the selected cluster when at least two of the clusters are snooped.

10. A data processing method of a snoop filter for a cache in a plurality of clusters comprising:
receiving an allocating request;
checking a counter indicator when a tag of the snoop filter is full; and
allocating a cache line of the snoop filter by invalidating data in the cache when the counter indicator is greater than a threshold.

11. The method of claim 10, further comprising:
increasing the counter indicator value by one when the counter indicator is less than the threshold.

12. The method of claim 10, further comprising
allocating the cache line when the tag of the snoop filter is not full.

13. A data processing method of a snoop filter for a cache in a plurality of clusters, comprising:
receiving a de-allocating request with an address;
checking a counter indicator when a miss of the address is responded by the snoop filter; and
decreasing the counter indicator value by one when the counter indicator is greater than zero.

14. The method of claim 13, further comprising
de-allocating a cache line when a hit of the address is responded by the snoop filter.
